(19) United States
(12) Patent Application Publication
(10) Pub. No.: US 2011/0295765 A1
(43) Pub. Date: Dec. 1, 2011

(54) Variable Annuity Product Management Method and System

(75) Inventors: Kevin L. Howard, Smithfield, KY (US); Paul D. Schneider, Naperville, IL (US); Scott W. Edblom, Cincinnati, OH (US)

(73) Assignees: Western & Southern Financial Group, Inc., Cincinnati, OH (US); Mid Atlantic Capital Group, Pittsburgh, PA (US)

(21) Appl. No.: 13/115,613

(22) Filed: May 25, 2011

Related U.S. Application Data
(60) Provisional application No. 61/348,025, filed on May 25, 2010.

(51) Int. Cl. G06Q 40/00

(52) U.S. Cl. 705/36 R; 705/37

(57) ABSTRACT

A computer-implemented method for providing and managing a variable annuity product capable of investing in exchange-traded funds, including: receiving, on a server computer, a request to allocate an amount of annuity assets comprising tax-deferred or tax-advantaged assets into at least one subaccount corresponding to a specified exchange-traded fund; allocating the amount of annuity funds into at least one subaccount; and initiating the purchase of at least one share of an exchange-traded fund relating to at least a portion of at least one unit of the at least one subaccount. A system and a computer program product for implementing the aforementioned method includes appropriately communicatively connected hardware components. Also disclosed is a computer-implemented method for reducing risk in a variable annuity product as well as a system and a computer program product for implementing the method which includes appropriately communicatively connected hardware components.

### CROSS REFERENCE TO RELATED APPLICATION

This application claims priority to U.S. Provisional Patent Application No. 61/348,025, filed May 25, 2010, entitled “Flexible Premium Variable Annuity,” the entire disclosure of which is herein incorporated by reference.

### BACKGROUND OF THE INVENTION

1. Field of the Invention

The present invention pertains to the fields of financial investment and insurance, particularly to computer-implemented systems and methods for managing and/or accruing distributions within and/or hedging a variable annuity account.

2. Description of Related Art

Annuities are financial products that typically involve a guarantee by the party issuing the annuity (the issuing company) to make a series of payments to the party who purchased and was issued the annuity (the purchaser). Variable annuities are contracts between a purchaser, also referred to as the contract owner, and an insurance company, whereby the insurance company agrees to make periodic payments to the contract owner immediately or at some future date. An annuitant is the measuring life of an annuity. The contract owner may be the annuitant.

Typically, variable annuity products offer purchasers downside protection, which provides a guarantee of a death benefit and/or lifetime payments, even if the investments made with the funds perform poorly. This downside protection often comes at a considerable annual cost to the purchaser. Further, variable annuity products do not allow purchasers to have control over their investments. This restriction is largely due to existing Internal Revenue Service rulings. Presently, Internal Revenue Code §817 precludes the offering of investment options that are generally available to the public through a variable annuity.

Exchange-traded funds (ETFs) are low-cost investment vehicles that have become increasingly popular in recent years. Their popularity is due, at least in part, to the products' low cost and tax benefits. ETFs hold assets, often track a specific stock index, and are traded on stock exchanges. ETFs may also allow for investors to delay payment of capital gains taxes until the final sale of an ETF. As of February 2011, the Investment Company Institute determined that there were 956 ETFs outstanding with assets of $1.035 trillion.

As the number of ETFs and their size has grown, there has been a sharp increase in the number of investment advisers who use ETFs as key elements in constructing client portfolios. These advisers range from sole proprietors to groups at major wirehouses. At the same time, large numbers of people are leaving the work force, both voluntarily and involuntarily, including many in the “baby boomer” generation. In many cases, these people are receiving large lump sum distributions from their employer's retirement savings plan that need to be rolled into an IRA to maintain their tax-advantaged status.

ETFs have not been made available in connection with variable annuities for both regulatory and structural reasons. Internal Revenue Code §817 is intended to prevent taxpayers from deferring taxes on publicly-available investments in amounts greater than the limits afforded by the rules for various tax-favored retirement plans, such as individual retirement accounts (IRAs) and 401(k) plans. Because variable annuities confer tax-deferred status on the investment options available through them, and because ETFs are available for purchase by the general public, the regulations effectively bar ETFs from being an investment option for variable annuities. Unlike insurance-dedicated mutual funds that can be sold only to insurance companies and limited categories of other investors, there are no limits on who can purchase an ETF, thus making them unavailable as an underlying investment option in a typical variable annuity.

Because of these limitations, the investment options typically offered through variable annuities are those which are made available only to those products or through other non-public investment vehicles, such as 401(k) plans. Variable annuities that do offer ETF options only do so indirectly via a “fund of funds” approach, wherein an active fund invests or allocates assets among various ETFs, with or without other securities. Until the present invention, variable annuities could not invest in a single, specific ETF, but rather only in a number of aggregated ETFs through the “fund of funds” approach. ETFs are not structurally suited for the typical variable annuity since they often provide cash payment of dividends and capital gains that affect the share price.

A further potential issue that arises based on the availability of ETFs through variable annuities is that of a price differential between the market closing price on one day and the market opening price the next day. Companies sell units to variable annuity purchasers and buy units back when the purchaser surrenders the variable annuity or reallocates their value among the investment options. The price of those units is set at the close of trading on the New York Stock Exchange, typically 4 p.m. Eastern Standard Time (EST). Having sold units to their customers based on the ETF's 4 p.m. EST price, the companies then must buy shares of the ETF, so that the companies hold the shares of the ETF that are the basis of the value of the units it sold. The markets in which ETF shares trade largely close at 4 p.m. Thus, the issuing companies bear the risk that the price of the ETF shares will increase between the 4 p.m. price used as the basis for the units sold to purchasers and the price the companies pay after 9:30 a.m. the next morning when trading in the ETF resumes on the exchange.

The risk that an issuing company faces as a result of this potential mismatch between sales of units to purchasers and the companies' purchases of the ETF shares underlying those units is of a potentially high magnitude. This risk was particularly evident during the 2008-2009 financial downturn, when news after markets closed led to huge swings between the prior night's close and the market open. If ETFs were to be invested in through a variable annuity, this price mismatch would result in an increased risk of loss to the company issuing the variable annuity, which would ultimately result in an increased cost for the purchaser of the annuity.

### SUMMARY OF THE INVENTION

It is, therefore, an object of the present invention to provide a variable annuity product management method and system that addresses or overcomes some or all of the drawbacks and deficiencies in connection with known variable annuity products. Preferably, the present invention provides a variable annuity product management method and system that facilitates the investment in exchange traded funds (ETFs), such as through the use of tax-deferred or tax-advantaged assets, e.g., an IRA, Roth IRA, a tax-qualified rollover from a 401(k), 403(b), 457, or similar plan under the Employee Retirement Income Security Act (ERISA). Preferably, the present invention provides a variable annuity product management method and system that minimizes or eliminates the risks presented by the price differential associated with purchasing and selling ETFs in order to provide a low cost variable annuity.

According to one preferred and non-limiting embodiment of the present invention, provided is a computer-implemented method for providing and managing variable annuity funds, including: receiving, on a server computer, a request to allocate an amount of annuity assets comprising tax-deferred or tax-advantaged assets into at least one subaccount corresponding to a specified exchange-traded fund; allocating the amount of annuity funds into at least one subaccount; and initiating the purchase of at least one share of an exchange-traded fund relating to at least a portion of at least one unit of the at least one subaccount.

In another preferred and non-limiting embodiment of the present invention, provided is a computer program product comprising a computer usable medium having control logic stored therein for causing a computer to manage variable annuity funds, the control logic including: first computer readable program code means for causing the computer to receive a request to allocate an amount of annuity assets comprising tax-deferred or tax-advantaged assets into at least one subaccount corresponding to a specified exchange-traded fund; second computer readable program code means for causing the computer to allocate the amount of annuity funds into at least one subaccount; and third computer readable program code means for causing the computer to initiate the purchase of at least one share of an exchange-traded fund relating to at least a portion of at least one unit of the at least one subaccount.

In a further preferred and non-limiting embodiment of the present invention, provided is a variable annuity fund creation and management system, including at least one computer having a computer readable medium with program instructions stored thereon, which, when executed by a processor of the computer, cause the processor to: receive a request to allocate an amount of annuity assets comprising tax-deferred or tax-advantaged assets into at least one subaccount corresponding to a specified exchange-traded fund; allocate the amount of annuity funds into the at least one subaccount; and initiate the purchase of at least one share of an exchange-traded fund relating to at least a portion of at least one unit of the at least one subaccount.

In a further preferred and non-limiting embodiment of the present invention, provided is a computer-implemented method for reducing risk in a variable annuity product, including: receiving, on a server computer, a request to invest assets in an index-based exchange-traded fund; determining a market price of said index-based exchange-traded fund; determining expected performance data of said index-based exchange-traded fund; identifying at least one index-based investment option having an expected performance substantially similar to said expected performance of said index-based exchange-traded fund; and communicating the identified at least one index-based investment option.

In a still further preferred and non-limiting embodiment of the present invention, provided is a computer program product comprising a computer usable medium having control logic stored therein for causing a computer to reduce risk in a variable annuity product, the control logic including: first computer readable program code means for causing the computer to receive a request to invest assets in an index-based exchange-traded fund; second computer readable program code means for causing the computer to determine expected performance data of said index-based exchange-traded fund; third computer readable program code means for causing the computer to identify at least one index-based investment option having expected performance data substantially similar to said expected performance data of said index-based exchange-traded fund; and fourth computer readable program code means for causing the computer to communicate the identified at least one index-based investment option.

In another preferred and non-limiting embodiment of the present invention, provided is a variable annuity fund risk-reduction system, including at least one computer having a computer readable medium with program instructions stored thereon, which, when executed by a processor of the computer, cause the processor to: receive a request to invest assets in an index-based exchange-traded fund; determine expected performance data of said index-based exchange-traded fund; identify at least one index-based investment option having expected performance data substantially similar to said expected performance data of said index-based exchange-traded fund; and communicate the identified at least one index-based investment option.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic diagram of a computer and network infrastructure according to the prior art;

FIG. 2 is a schematic diagram of one embodiment of a variable annuity management system according to the principles of the present invention;

FIG. 3 is a schematic diagram of one embodiment of a system relating to hedging risks associated with variable annuities investing in exchange-traded funds according to the principles of the present invention; and

FIG. 4 is a schematic diagram of another embodiment of a variable annuity management system according to the principles of the present invention.

### DESCRIPTION OF THE PREFERRED EMBODIMENTS

For purposes of teaching the present invention, preferred embodiments of the methods and devices of the invention are described below. It will be appreciated by the person skilled in the art that other alternative and equivalent embodiments of the invention can be conceived and reduced to practice without departing from the true spirit of the invention, the scope of the invention being limited only by the appended claims. It is to be understood that the invention may assume various alternative variations and step sequences, except where expressly specified to the contrary.

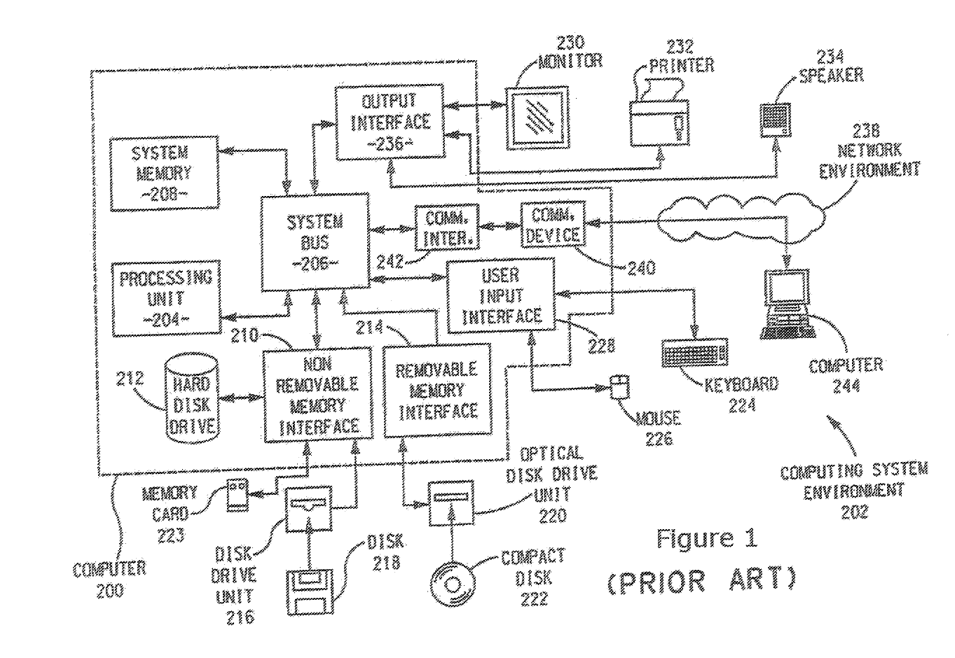

The present invention may be implemented on a variety of computing devices and systems, wherein these computing devices include the appropriate processing mechanisms and computer-readable media for storing and executing computer-readable instructions, such as programming instructions, code, and the like. As illustrated in FIG. 1 and according to the prior art, a schematic and block diagram of exemplary computing devices, in the form of personal computers 200, 244, in a computing system environment 202 are provided. This computing system environment 202 may include, but is not limited to, at least one computer 200 having certain components for appropriate operation, execution of code, and creation and communication of data. For example, the computer 200 includes a processing unit 204 (typically referred to as a central processing unit or CPU) that serves to execute computer-based instructions received in the appropriate data form and format. Further, this processing unit 204 may be in the form of multiple processors executing code in series, in parallel, or in any other manner for appropriate implementation of the computer-based instructions.

In order to facilitate appropriate data communication and processing information between the various components of the computer 200, a system bus 206 is utilized. The system bus 206 may be any of several types of bus structures, including a memory bus or memory controller, a peripheral bus, or a local bus using any of a variety of bus architectures. In particular, the system bus 206 facilitates data and information communication between the various components (whether internal or external to the computer 200) through a variety of interfaces, as discussed hereinafter.

The computer 200 may include a variety of discrete computer-readable media components. For example, this computer-readable media may include any media that can be accessed by the computer 200, such as volatile media, non-volatile media, removable media, non-removable media, etc. As a further example, this computer-readable media may include computer storage media, such as media implemented in any method or technology for storage of information such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 200. Further, this computer-readable media may include communications media, such as computer-readable instructions, data structures, program modules, or other data in a modulated data signal such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, Bluetooth or any acceptable wireless communication format or technology, etc.). Of course, combinations of any of the above should also be included within the scope of computer-readable media.

The computer 200 further includes a system memory 208 with computer storage media in the form of volatile and non-volatile memory, such as ROM and RAM. A basic input/output system (BIOS) with appropriate computer-based routines assists in transferring information between components within the computer 200 and is normally stored in ROM. The RAM portion of the system memory 208 typically contains data and program modules that are immediately accessible to or presently being operated on by processing unit 204, e.g., an operating system, application programming interfaces, application programs, program modules, program data, and other instruction-based computer-readable code.

The computer 200 may also include other removable or non-removable, volatile or non-volatile computer storage media products. For example, the computer 200 may include a non-removable memory interface 210 that communicates with and controls a hard disk drive 212, i.e., a non-removable, non-volatile magnetic medium; and a removable, non-volatile memory interface 214 that communicates with and controls a magnetic disk drive unit 216 (which reads from and writes to a removable, non-volatile magnetic disk 218), an optical disk drive unit 220 (which reads from and writes to a removable, non-volatile optical disk, such as a CD ROM 222), a Universal Serial Bus (USB) port for use in connection with a removable memory card 223, etc. However, it is envisioned that other removable or non-removable, volatile or non-volatile computer storage media can be used in the exemplary computing system environment 202, including, but not limited to, magnetic tape cassettes, DVDs, digital video tape, solid state RAM, solid state ROM, etc. These various removable or non-removable, volatile or non-volatile magnetic media are in communication with the processing unit 204 and other components of the computer 200 via the system bus 206. The drives and their associated computer storage media discussed above and illustrated in FIG. 1 provide storage of operating systems, computer-readable instructions, application programs, data structures, program modules, program data, and other instruction-based computer-readable code for the computer 200 (whether duplicative or not of the information and data in the system memory 208).

A user may enter commands, information, and data into the computer 200 through certain attachable or operable input devices, such as a keyboard 224, a mouse 226, etc., via a user input interface 228. Of course, a variety of such input devices may be utilized, e.g., a microphone, a trackball, a joystick, a touchpad, a touch-screen, a scanner, etc., including any arrangement that facilitates the input of data and information to the computer 200 from an outside source. As discussed, these and other input devices are often connected to the processing unit 204 through the user input interface 228 coupled to the system bus 206, but may be connected by other interface and bus structures, such as a parallel port, game port, or a USB. Still further, data and information can be presented or provided to a user in an intelligible form or format through certain output devices, such as a monitor 230 (to visually display this information and data in electronic form), a printer 232 (to physically display this information and data in print form), a speaker 234 (to audibly present this information and data in audible form), etc. All of these devices are in communication with the computer 200 through an output interface 236 coupled to the system bus 206. It is envisioned that any such peripheral output devices be used to provide information and data to the user.

The computer 200 may operate in a network environment 238 through the use of a communications device 240, which is integral to the computer or remote therefrom. This communications device 240 is operable by and in communication with the other components of the computer 200 through a communications interface 242. Using such an arrangement, the computer 200 may connect with or otherwise communicate with one or more remote computers, such as a remote computer 244, which may be a personal computer, a server, a router, a network personal computer, a peer device, or other common network node, and typically includes many or all of the components described above in connection with the computer 200. Using appropriate communications devices 240, e.g., a modem, a network interface, or adapter, etc., the computer 200 may operate within and communicate through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 200, 244 may be used.

As used herein, the computer 200 includes or is operable to execute appropriate custom-designed or conventional software to perform and implement the processing steps of the method and system of the present invention, thereby forming a specialized and particular computing system. Accordingly, the presently-invented method and system may include one or more computers 200 or similar computing devices having a computer-readable storage medium capable of storing computer-readable program code or instructions that cause the processing unit 204 to execute, configure, or otherwise implement the methods, processes, and transformational data manipulations discussed hereinafter in connection with the present invention. Still further, the computer 200 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

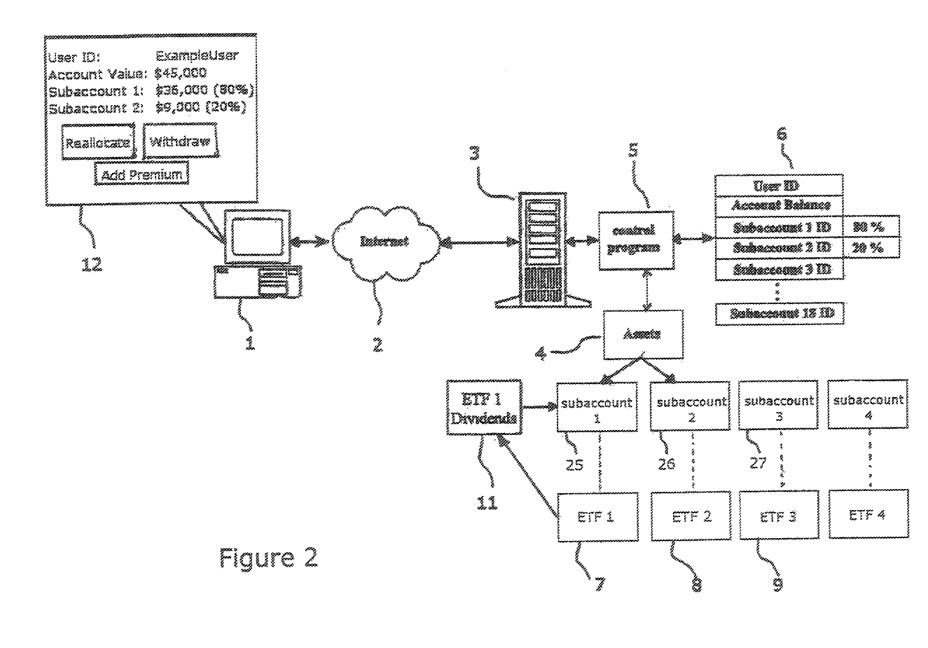

Referring now to FIG. 2, a system for providing a variable annuity, including accrual and reinvestment of dividends or other distributions from ETFs, is shown. A purchaser at a client node 1, through a graphical user interface (GUI) 12, accesses a server 3 maintained or utilized by the issuing company through the Internet 2. Through a control program 5, a purchaser is able to allocate assets 4 among subaccounts 25, 26, 27 each of which corresponds to an ETF 7, 8, 9. The issuing company invests in ETFs 7, 8, 9 based on a monetary amount of assets and/or based on a percentage of total assets invested in each subaccount 25, 26, 27 that invests in each corresponding ETF. The control program (or system) can include an interface or other program instructions to initiate, facilitate, communicate, and/or perform the investment or transaction. The control program additionally stores relevant information in a data structure 6, such as a table, which stores information. Relevant information may include identifying information for a particular purchaser, identifying information for a particular purchaser's chosen subaccounts investing in corresponding ETFs and allocation amounts for each chosen subaccount investing in a corresponding ETF. Further, distributions or dividends 11 issued or declared by an exchange-traded fund 7 are reinvested in the subaccount 25 that corresponds to that exchange-traded fund 7 or other subaccounts 26, 27 as directed by the contract owner.

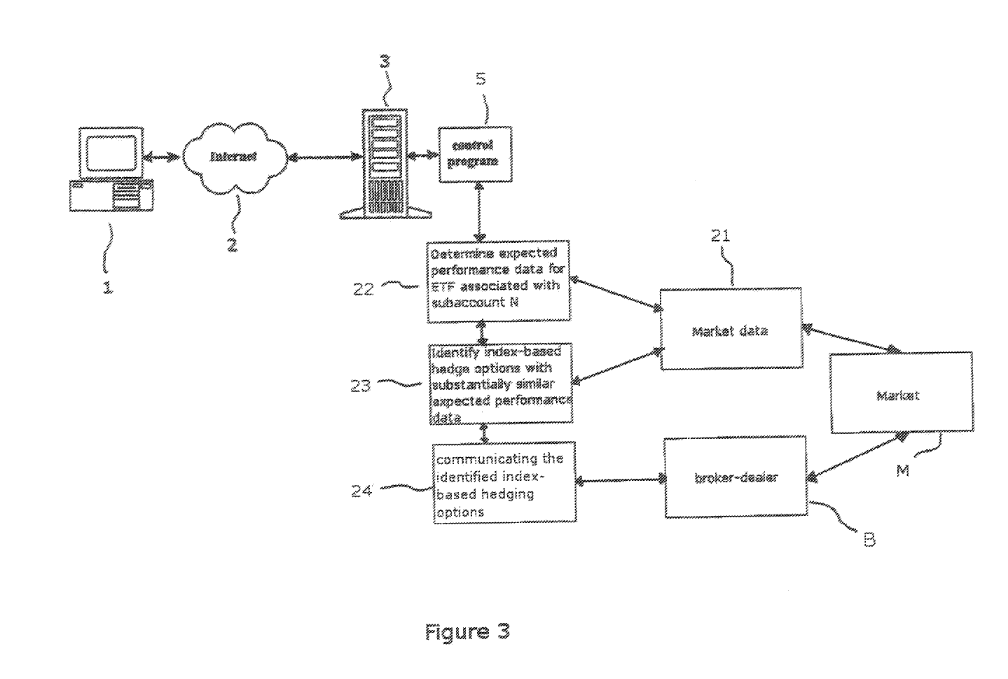

Referring now to FIG. 3, a system for hedging risks related to a variable annuity fund is shown. A purchaser or contract owner at a client node 1 accesses a server 3 maintained or utilized by the issuing company through the Internet 2. At the client node, the purchaser requests to invest assets in a subaccount associated with a specified ETF. Through a control program 5, a function 22 is executed to determine expected performance data for the ETF associated with the relevant subaccount, which may be based at least partially on market data 21, and which is formulated and/or compiled based on actual historical occurrences in the market M. After determining expected performance data of the ETF, the control program executes a function 23 to identify index-based hedge (or investment) options having substantially similar expected performance data based on market data 21, such as through a database lookup or matching process. After identifying one or more index-based hedge (or investment) options, the control program then executes a function 24 to communicate the identified index-based hedge (or investment) option, such as to a broker-dealer B, investment adviser, hedging consultant, or the like, who initiates the purchase request or otherwise facilitates the purchase of the identified index-based hedge (or investment) option from the market M. This identification may occur through any known program or means to store, analyze, and parse data, such as storage of data or information in a parseable database.

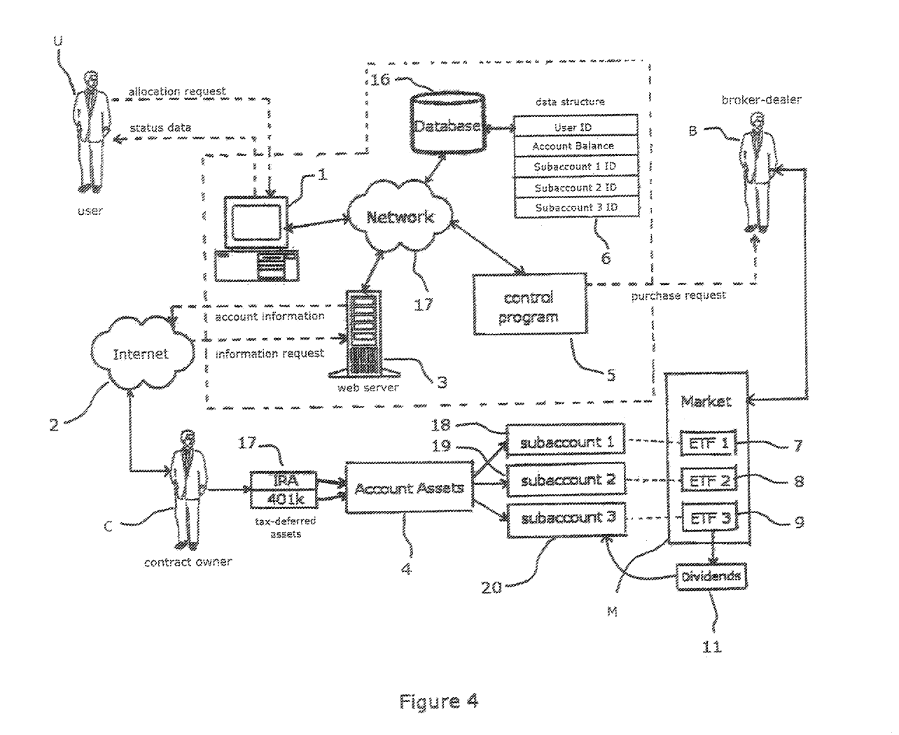

Referring now to FIG. 4, a further preferred and non-limiting embodiment of a system for accruing and providing a variable annuity is shown. A contract owner C has tax-deferred or tax-advantaged assets 17 which transfer or roll-over into a new account 4. A user U, which may also be the contract owner C or may be a representative of the issuing company, sends a request to allocate the contract owner's assets 4 into one or more subaccounts 18, 19, 20, each of which correspond to an ETF 7, 8, 9 that is traded on the market M. The allocation request is inputted into a computer 1, e.g. a client node, which is connected to an internal network 17, which may be owned or maintained by the issuing company. A database 16 is connected to the network and contains data 6, in a table or other form of data structure. A control program 5 is also connected to the network 17 to process requests and initiate payments. A server 3 is also connected to the network 17 for external access through the Internet 2. Once an allocation request is received by the network 17 and processed by the control program 5, the system communicates, facilitates, and/or initiates a purchase or sale request and sends the request to a broker-dealer B, who has access to the market M on which the ETFs 7, 8, 9 are traded. The broker-dealer B purchases or sells shares of an ETF which correspond to one of the subaccounts 18, 19, 20 in which the contract owner C has allocated his assets 4. Dividends or other distributions 11 issued or declared by an ETF 9 may be reinvested back into the corresponding subaccount 20 or subaccount 18 or 19. The contract owner C may access account information through the Internet 2 or in any known manner, such as through a generated graphical user interface or other control interface.

The variable annuity contract of the present invention may be issued as a traditional Individual Retirement Account (IRA), a Roth IRA or a Simplified Employee Pension (SEP) IRA. The contract may be purchased by the transfer of funds or rollover from an existing IRA or from certain other qualified plans, such as a 401(k), 403(b), 457 or similar plan under the Employee Retirement Income Security Act (ERISA). Funds may also be transferred from another annuity contract that is an IRA. Similarly, the funds (or assets) may be any type of tax-deferred or tax-advantaged monies.

In one preferred and non-limiting embodiment of the present invention, a purchaser's retirement benefit distributions roll-over into an IRA, retaining the tax advantages of those retirement benefits. The retirement benefit distributions may come from one or multiple tax-qualified (and/or tax-deferred or tax-advantaged) retirement plans. The purchaser can then create a custom investment portfolio by specifying which subaccounts investing in corresponding ETFs out of a list of ETF-based subaccounts that the purchaser wishes to invest in, and how much that investment should be (either as a percentage or a specified amount). The purchaser can accomplish this through a communication means, which can include, but is not limited to, a computer connected to the Internet with control means and display means. In one possible embodiment, the purchaser chooses the subaccounts investing in corresponding ETFs she wishes to invest in through a graphical user interface (GUI) presented through a website or computer application. In another embodiment, a purchaser can choose the subaccounts investing in corresponding ETFs she wishes to invest in by transmitting a request to a broker or representative of the issuing company specifying which subaccounts she wishes to invest in. In the latter example, the broker or representative of the issuing company may then electronically store and/or transmit the purchaser's selection to a server of the issuing company.

In one preferred and non-limiting embodiment of the present invention, a purchaser's funds (or assets) are initially allocated into an account. The purchaser then has the option of choosing several subaccounts in which to apportion or allocate some or all of the purchaser's funds. Each subaccount invests in shares of a particular, individual and specific ETF and can be named to coordinate with the name of the ETF in which it invests. The subaccounts themselves contain units, which relate to but are not necessarily proportional to the shares of the underlying ETFs. The ETF shares may be considered to be or correspond to a fraction or a percentage of the corresponding subaccount units. When an issuing company purchases ETF shares in its subaccounts, each subaccount then issues units (whether fractional or whole number values) that correspond to the respective ETF's shares. The purchaser then has the ability to allocate her funds to particular subaccounts based on which ETFs the purchaser wishes to invest in, either as a percentage or a specified amount. This allocation request may be electronically transmitted to the issuing company through a GUI or other form of electronic request.

In one preferred and non-limiting embodiment of the present invention, each ETF available through a subaccount is a registered investment company, shares of which may be traded throughout the day on exchanges, such as the New York Stock Exchange Arca, Inc. ETF shares may trade at, above, or below their net asset value. For purposes of valuing subaccount units, however, the issuing company may choose to use the daily closing price of each ETF on its primary exchange. Further, each ETF available through a subaccount may seek investment results that correspond to an index. The returns on the ETF shares will not precisely correlate with the performance of the index, but generally seek to track the performance of the index as closely as possible. Purchasers are unable to invest directly in an index. Therefore, the present invention provides an improvement over existing variable annuity products by investing in passively managed ETFs, resulting in substantially lower underlying fund costs and/or available investment options that seek to track a wider, more diversified variety of indexes than those associated with most existing variable annuities. These steps are preferably implemented on a specially-programmed computer or network of computers.

In one preferred and non-limiting embodiment of the present invention, premiums or funds (assets) allocated to subaccounts are used to purchase or initiate the purchase of shares of the corresponding ETF at the price as of the next close of the exchange upon which the ETF is based. For example, if the ETF is based on the New York Stock Exchange, units of the ETF are purchased at the price as of the next close of the New York Stock Exchange.

The value of each subaccount will vary due to the performance of the corresponding ETF. The subaccounts each invest in the shares of a distinct and specific ETF, which is a type of registered investment company commonly called a mutual fund. However, unlike mutual fund shares, ETF shares are traded throughout the day on exchanges. ETF shares may trade at, above, or below their net asset value. The subaccount units can be valued based on the daily value of the ETF at the close of business of the exchange on which it trades, such as the New York Stock Exchange.

In one preferred and non-limiting embodiment of the present invention, shares of an ETF are purchased by the issuing company when a purchaser contributes a new premium to their contract, allocated to a particular subaccount, or when a purchaser transfers amounts into a particular subaccount. ETF shares and corresponding units are sold when a purchaser makes withdrawals or transfers amounts from one subaccount to another. Shares of an ETF (and corresponding units) are also sold to pay a death benefit or an annuity option. An annuity option is an arrangement under which income payments are made by the issuing company to a purchaser. The number of units of an ETF subaccount purchased or sold in any subaccount is calculated by dividing the dollar amount of the transaction by the next computed unit value for that subaccount, calculated as of the next close of business of the New York Stock Exchange. Each unit of an ETF subaccount represents a fractional undivided interest in the assets held in the related subaccount. If units of a subaccount are sold, the fractional undivided interest represented by each remaining unit will be increased. If additional units are issued by any subaccount, the fractional undivided interest represented by each remaining unit will be decreased. Units of a subaccount will remain outstanding until sold by the purchaser of a contract. Additionally, the unit value of each subaccount will fluctuate with the investment performance of the corresponding ETF, which reflects the investment income and realized and unrealized capital gains and losses of the ETF, and the expenses associated with the ETF.

In one preferred and non-limiting embodiment of the present invention, the subaccounts that invest in the ETFs also hold an accrual for any dividends or other distributions declared by the ETFs. These dividends or other distributions are invested back into the ETF from which they were issued or declared on the next business day or, alternatively, are invested in other ETFs.

According to one preferred and non-limiting embodiment of the invention, the issuing company may require purchasers to pay fees and expenses (or agree to pay fees and expenses, such as through an electronic contract or communication) associated with buying, owning, withdrawing from and surrendering their contracts. These expenses may include withdrawal charges, mortality and expense risk charges, administration charges and optional guaranteed lifetime withdrawal benefit charges. The withdrawal charge can be calculated as a percentage of premiums, e.g. seven percent, and may decrease over time and be eliminated for each premium after the premium reaches a specified age, e.g. five years. The various annual charges associated with contracts can have a maximum charge amount and a current charge amount at the time purchasers purchase their contracts. The annual mortality and expense risk charge, for example, may have a maximum charge of 1% and a current charge of 1%, meaning that a purchaser must pay 1% for this charge and that this charge will not exceed 1% during the life of the contract. Likewise, the annual administration charge can be set at a current charge of 0.75% and a maximum charge of 0.75%. The optional guaranteed lifetime withdrawal benefit annual charge can be set at a current charge of 0.60% and a maximum charge of 1.50%, meaning that the purchaser will pay a 0.60% fee associated with the guaranteed lifetime withdrawal benefit and may in the future be charged as much as 1.50% for that benefit. Optionally, the issuing company may also specify totals of all associated charges, transmitting to a prospective purchaser the highest possible total separate account annual expenses as both a current figure, e.g. 2.55%, and a maximum figure, e.g. 3.25%.

Further, there may be charges associated with the exchange-traded funds or other investment funds that the purchaser must pay or agree to pay through an electronic contract or communication. These fund operating expenses can be represented in terms of minimum and maximum annual charges that a purchaser may have to pay periodically during the time that the purchaser owns the contract, e.g. a minimum of 0.09% and a maximum of 0.50%. These minimum and maximum amounts are consistently lower than comparable actively managed mutual funds. These minimum and maximum figures respectfully represent the ETF or other investment option with the lowest total annual gross expenses, and the ETF or other investment option with the highest total annual gross expenses.

In one preferred and non-limiting embodiment of the present invention, the method and system provides several rights to the purchaser over the variable annuity contract as owner of that contract, including the right to contribute, transfer and withdraw money, the right to invest their premiums in the available investment options, the right to elect the optional benefits available at the time the purchaser purchases the contract, the right to elect an annuity option and the right to name one or more beneficiaries to receive a death benefit associated with the contract. These functions (rights) can be provided upon set up of the user in the system or at any time during the process, as appropriate.

In one preferred and non-limiting embodiment of the present invention, the issuing company utilizes third-party broker-dealers to facilitate the process of purchasing units or shares of ETFs and other investment options, such that these broker-dealers are users of the method and system. Alternatively, these services could be offered in-house by the issuing company.

In one preferred and non-limiting embodiment of the present invention, a purchaser's account value is determined by adding the values of that purchaser's investment options, e.g., ETFs and other funds. Any amount of assets allocated to a subaccount will increase or decrease depending on the investment experience of the ETF or other fund. The value of premiums allocated to the subaccounts may not be guaranteed by the issuing company. Further, a purchaser's account value is subject to various charges. A purchaser's surrender value is equal to that purchaser's account value, minus any withdrawal charge and applicable premium tax.

In one preferred and non-limiting embodiment of the present invention, the issuing company may set a minimum account value, e.g. $2,000. If a purchaser's account value falls below the specified minimum account value, and the issuing company has not received any premiums from that purchaser for two years, the issuing company may terminate the contract and pay the purchaser the account value. In such a case, the issuing company may electronically notify (or generate or initiate the notification of) the purchaser in advance and may give the purchaser a set period of time, e.g. 60 days, to contribute additional premiums in order to keep their contract in force. Further, the issuing company may choose not to require a minimum account balance if, for example, the purchaser has transmitted a request to participate in a guarantee of lifetime withdrawal benefits program or other optional programs or riders.

In one preferred and non-limiting embodiment of the present invention, the issuing company may offer a free-look period, during which a purchaser may cancel their contract within a number of days, e.g. 10 days, after the purchaser receives the contract. This free-look period may be extended if required by law or for any other reason specified by the issuing company. Further, the issuing company may still hold the purchaser responsible for any fees or charges incurred during the free look period. If the purchaser's state requires the issuing company to return the purchaser's premium, or some amount other than the purchaser's account value, the issuing company may return the greater of the amount required by state law and the purchaser's account value via an electronic funds transfer or other method of payment.

In one preferred and non-limiting embodiment of the present invention, the issuing company may maintain or create a unit investment trust, or another type of investment company. Under applicable state law, e.g. that of Ohio or New York, the issuing company may own the assets of the investment company and may use those assets to support the subaccounts of the various variable annuity contracts that it issues. In one preferred and non-limiting embodiment of the present invention, the issuing company may reserve the right to add, substitute, or close subaccounts and may additionally limit the amount that a purchaser may invest in one or more of the subaccounts on a nondiscriminatory basis, and using the functionality of the system.

In one preferred and non-limiting embodiment of the present invention, the issuing company may provide or grant rights to the purchasers to reallocate all or part of their account value among the available subaccounts. The issuing company may implement a waiting period, e.g. 60 days, after a purchaser reallocates their account value, or otherwise voluntarily allocates assets, preventing that purchaser from reallocating their account value before the waiting period has elapsed. An issuing company may allow for purchasers to reallocate their account value by initiating an electronic request through the Internet, by electronic communication with a representative or through any other means of communication. The issuing company may also refuse any reallocation request if it believes that a specific request or group of requests may have a detrimental effect on unit values.

In one preferred and non-limiting embodiment of the present invention, the system may present one or more asset allocation models in connection with purchasers' variable annuities with or without extra charge. Asset allocation is the process of investing in different asset classes such as equity funds, fixed income funds, and alternative funds, depending on the purchasers' personal investment goals, tolerance for risk, and investment time horizon. By spreading their money among a variety of asset classes, purchasers may be able to reduce the risk and volatility of investing.

In one preferred and non-limiting embodiment of the present invention, the issuing company may reduce or eliminate the withdrawal charge for individuals or a group of individuals if it anticipates expense savings. The issuing company may do this based on the size and type of the group, the amount of the premium, or whether there is some relationship with the issuing company. The withdrawal charge may be reduced or eliminated automatically through the functionality of the system by processing attributes of a particular user or transaction with stored data and rules to determine whether a particular user or transaction is eligible for reduction or elimination of the withdrawal charge. Examples of qualifying attributes may include being an employee of the issuing company or an affiliate, receiving distributions or making internal transfers from other contracts the issuing company issued, or transferring amounts held under qualified plans that the issuing company, or its affiliates, sponsored.

In one preferred and non-limiting embodiment of the present invention, the issuing company may initiate payment of a commission to the sales representative equal to a maximum percentage of premiums, e.g. 5%, and up to a maximum percentage of trail commission, e.g. 0.70%, paid on an account value starting in the second contract year. Payments may be processed automatically by the system and made via electronic funds transfers or other form of payment. Commissions may vary due to differences between states, sales channels, sales firms and special sales initiatives. A broker-dealer or financial institution that distributes the issuing company's variable annuity contracts may receive additional compensation from the issuing company for training, marketing or other services provided. These services may include special access to sales staff, and advantageous placement of the issuing company's products. The issuing company may choose not to make an independent assessment of the cost to the broker-dealer or financial institution of providing such services. Additionally, the issuing company may enter into agreements with broker-dealer firms under which it pays varying amounts on premiums paid, but no more than a specified percentage, e.g. 0.25%, for enhanced access to its registered representatives.

In one preferred and non-limiting embodiment of the present invention, the issuing company may set minimum amounts for initial premiums and additional premiums, e.g. $25,000 minimum initial premium and $1,000 minimum additional premium. Further, the issuing company may set a maximum total premium without prior approval, e.g. $1,000,000, and a maximum additional premium at up to applicable IRA limits each calendar year plus permissible transfers and rollovers. These minimums and maximums may be electronically stored and used as rules to determine whether a purchaser's allocations and requests made through a GUI are allowable. If a purchaser's allocations or request is not allowable, the system may be designed to generate an error message notifying the purchaser of the relevant rules.

In one preferred and non-limiting embodiment of the present invention, the issuing company may require purchasers to determine whether any premium qualifies as a permissible contribution subject to favorable tax treatment under the Internal Revenue Code. The purchaser may also be required to determine whether such amount qualifies as a permissible transfer or rollover contribution under the Internal Revenue Code. For example, the purchaser cannot roll over from a SIMPLE IRA during the first two years of participation in the SIMPLE IRA and cannot roll over after-tax contributions that are included in the other plans. Further, the purchaser cannot roll over distributions that are part of a series of substantially equal payments made over the purchaser's life expectancy, distributions made for a specified period of 10 years or more, required minimum distributions or hardship distribution. These rules may be transmitted to purchasers and prospective purchasers in the form of data viewable through a GUI.

In one preferred and non-limiting embodiment of the present invention, the issuing company may refuse additional premiums if: (1) the purchaser has allocated some or all of the premium to an investment option, to which the issuing company is no longer accepting additional premiums; (2) the additional premium does not meet the issuing company's set minimum additional premium amount or exceeds its maximum premium amount for the annuity contract or for a specific investment option; (3) the total premiums paid under all annuity contracts issued by the company, or its affiliates, on the purchaser's life exceed $1,000,000; (4) the issuing company believes that the additional premium is being made by or on behalf of an institutional investor; or (5) for any reason allowed by law. Such refusals may be calculated based on information transmitted by purchasers to the issuing company. If the system recognizes that an additional premium should be refused, an electronic notification may be generated and transmitted to the purchaser.

In one preferred and non-limiting embodiment of the present invention, the purchasers' premiums are invested in the investment options they select. Each premium is credited as of the date the issuing company receives the premium in good order at the company's processing office or headquarters, except that additional time may be allowed for the application of the initial premium under applicable law. Good order exists when the issuing company has the complete information it requires to process a purchaser's application or any request. The system may automatically determine when good order exists and a purchaser has successfully transmitted all requisite information and, in such instances, an electronic notification may be generated and transmitted to the purchaser.

In one preferred and non-limiting embodiment of the present invention, initial premium allocated to the subaccounts may be priced at the unit value determined no later than two business days after receipt of a completed application (including all necessary related information). If the application is not complete, the issuing company may retain the initial premium for up to five business days while attempting to complete it. If the application is not completed within five business days, the purchaser may be informed of the reason for the delay. The initial premium may be returned unless the purchaser specifically allows the issuing company to hold the premium until the application is completed.

In one preferred and non-limiting embodiment of the present invention, a purchaser's investment in the subaccounts is used to purchase shares of a corresponding ETF. On any given day, the value a purchaser has in a subaccount is the number of units the purchaser has in that subaccount multiplied by the unit value. The units of each subaccount have a different unit value. Units are purchased when a purchaser contributes new premium to their contract or transfers amounts to a subaccount. Units are redeemed (sold) when a purchaser makes withdrawals or transfers amounts out of a subaccount into a different subaccount. The issuing company may also redeem units to pay the death benefit or if the purchaser elects an annuity option, or as permitted or required by law. The number of units purchased or redeemed in any subaccount is calculated by dividing the dollar amount of the transaction by the next computed unit value for that subaccount, calculated as of the next close of business of the New York Stock Exchange. Each unit represents a fractional undivided interest in the assets held in the related subaccount. If units of any subaccount are redeemed, the fractional undivided interest represented by each remaining unit will be increased. If additional units are issued by any subaccount, the fractional undivided interest represented by each remaining unit will be decreased. Units will remain outstanding until redeemed by a contract owner. The unit value of each subaccount will fluctuate with the investment performance of the single and specific corresponding ETF in which it invests, which reflects the investment income, realized and unrealized capital gains and losses of the ETF, and the ETF's expenses.

In one preferred and non-limiting embodiment of the present invention, the issuing company may allow purchasers to initiate requests to withdraw funds as often as purchasers wish, subject to specified rules. Possible rules may include a minimum withdrawal amount, e.g. $250, and a minimum account value which must remain subsequent to a partial withdrawal, e.g. $20,000. These rules can be used to electronically determine whether a purchaser's withdrawal request is allowable. If a request is deemed to be not allowable, an electronic notification may be generated and transmitted to the purchaser. Further, the issuing company may provide a free withdrawal amount that may be withdrawn without adherence to any minimum account value. A free withdrawal amount may be allowed once during a specified time period, e.g. one year, and may be calculated based on a percentage of a purchaser's account value on the date of the withdrawal or as of the most recent contract anniversary. A required minimum distribution, an annual withdrawal amount required under the Internal Revenue Code based on the prior calendar year-end fair market value of the contract, may also cause some or all of the withdrawal rules to be invoked.

In one preferred and non-limiting embodiment of the present invention, any withdrawals may be taken from the subaccounts or other investment options, pro rata, in the same proportion their value bears on a purchaser's total account value. For example, if a purchaser's account value is divided in equal 25% portions among four subaccounts, 25% of the account value will come from each of the purchaser's subaccounts when that purchaser successfully initiates a request to make a withdrawal. The issuing company may also transmit a notification regarding required withdrawal charges.

In one preferred and non-limiting embodiment of the present invention, the issuing company may provide a death benefit to a designated beneficiary if a purchaser dies before the annuity date. The annuity date is any date on or before the maturity date that a purchaser elects an annuity option. The death benefit may be the greater of the purchaser's account value on the date of the purchaser's death or the purchaser's total premiums minus proportionate adjustments for partial withdrawals, including any withdrawal charge. The amount of the death benefit may be electronically calculated based on stored data and transmitted to any designated beneficiaries. A proportional adjustment means that the purchaser's death benefit will be reduced by the same percentage as the purchaser's withdrawal bears to the purchaser's account value at the time of withdrawal. The issuing company may transmit various options to death benefit beneficiaries including the options take a lump sum, to defer the benefit for a specified number of years, to treat the contract as an inherited IRA, or any other option predetermined by the issuing company.

In one preferred and non-limiting embodiment of the present invention, the purchaser's contract may be continued in their spouse's name as the owner. If spousal continuation is elected, the issuing company may increase the continued contract's account value to the same amount that would have been paid to the surviving spouse had he or she taken the death benefit as a lump sum distribution. This increase will be added to the subaccounts the purchaser had selected on a pro rata basis. For example, if the account value at death was $100,000, but the issuing company would have paid out a death benefit of $115,000, the surviving spouse's contract will continue with $115,000 as the account value. When the surviving spouse dies, the death benefit will be paid to the beneficiary named by the surviving spouse.

The unit value of each subaccount for any given business day is equal to the unit value for the previous business day, multiplied by the net investment factor for that subaccount on the current business day. The unit value may be electronically calculated based on stored data and electronically available data and transmitted to a purchaser. The net investment factor measures the investment performance of a subaccount from one business day to the next. The net investment factor is determined by dividing the net asset value of the subaccount for that valuation period by the net asset value of the subaccount for the preceding valuation period and then subtracting from that result the daily equivalent of the annual separate account charges for each calendar day since the last day that a unit value was determined. For example, a Monday calculation will include charges for Saturday and Sunday. Generally, this means that the issuing company adjusts unit values to reflect the change in value of the fund shares, for the separate account charges and, if elected, any additional charges for riders or guarantees.

In one preferred and non-limiting embodiment of the present invention, the issuing company may make the annuity option available anytime on or after the purchaser's first contract anniversary until the maturity data of the contract. Further, the purchaser may elect their annuity option by transmitting a request to the issuing company any time on or after their first contract anniversary and before the maturity date of the contract. Upon the maturity date, the purchaser may elect to receive a lump sum of their account value, or they may elect an annuity option. An annuity option can provide for fixed payments, which may be made monthly, quarterly, semi-annually or annually. For any annuity, the minimum payments may be set at a minimum, e.g. $100. If the minimum monthly payment under a guaranteed annuity option would be less than some specified amount, e.g. $20, the issuing company may choose to pay the purchaser a lump sum of their account value instead. The guaranteed annuity options may be single life and ten years certain or joint life and ten years certain. These options provide a fixed life income annuity with 10 years of payments guaranteed.

By utilizing ETFs, a company issuing a variable annuity is able to offer the annuity at a lower cost than competing variable annuity products. For example, in one embodiment of the present invention, the arithmetic average cost of the ETFs offered is 20 basis points (0.20%), compared to an average cost of 97 basis points (0.97%) for actively managed and indexed funds offered through the universe of variable annuities. (Source: Morningstar Annuity Research Center, 4^{th} Quarter 2009). This in turn provides cost advantages for the total expenses borne by the variable annuity of the present invention. In one aspect of the present invention, the total expenses of the variable annuity are 1.95%, calculated based on the average ETF cost, compared to the 2.5% total expenses associated with the average variable annuity contract.

With index-based ETFs, in contrast to actively managed mutual funds, the composition of an ETF's portfolio is totally transparent. Each day, before the opening of the exchange on which the ETF trades, the ETF's investment adviser must make publicly available, typically through a website, a list of the securities used to purchase new shares of the ETF. In addition to this daily disclosure, the ETF's prospectus, which is reviewed by the United States Securities and Exchange Commission (SEC), must set forth the ETF's investment objective. For an index-based ETF, the investment objective may contain the following language: “The ETF seeks investment returns that correspond generally to the price and yield performance, before fees and expenses, of the [selected index].”

The use of index-based ETFs results in lower breakage risk to an issuing company because SEC rules and policies require that at least 80% of an ETF's assets be invested in securities of the selected index and that the remaining assets be invested in assets designed to help the ETF's performance mirror, to the extent possible, the performance of the index. The lower breakage risk associated with the present invention variable annuity leads to lower costs for purchasers because the issuing company does not need to impose a charge to compensate itself for assuming the breakage risk.

The lower breakage risk associated with the present invention variable annuity also leads to lower costs for the issuing company because it is able to hedge this risk better and at a lower cost than if active mutual funds were utilized.

In one preferred and non-limiting embodiment of the present invention, the variable annuity contract can include a promise for guaranteed lifetime payments, regardless of how a purchaser's investments perform. This guarantee may be issued for an additional annual charge, upon the completion of a contract generated by or input into a computer system, in which the purchaser promises to make additional payments, and may involve limiting the purchaser's selection of ETFs to further reduce risk. The presently-invented system can also be programmed to administer the terms of the contract, and the purchaser data from an application may be input into the system for that individualized contract. The ability to offer such a guarantee without incurring imprudent risk, as well as the amount of the additional charge for the guarantee, depends upon the ability of the issuing company to hedge the market risk associated with providing such guarantees, which ability is improved by the present invention.

In one preferred and non-limiting embodiment of the present invention, the promise for guaranteed lifetime payments can be in the form of a rider. The issuing company may offer individual riders or spousal riders. An individual rider covers the purchaser and a spousal rider covers both the purchaser and the purchaser's spouse.

In one preferred and non-limiting embodiment of the present invention, the issuing company (or system) may transmit or communicate information to purchasers data representing a lifetime payment amount that reflects the amount the issuing company guarantees that a particular purchaser will receive each calendar year for that purchaser's lifetime or, if the spousal rider was selected, for as long as the purchaser or the purchaser's spouse is alive. Purchasers or purchasers' spouses are eligible to begin receiving a lifetime payment amount at a date which is determined by the issuing company based on age and/or contract date. The lifetime payment amount may be equal to the applicable withdrawal percentage multiplied by the benefit base on January 1 of each year on or after the lifetime payment amount eligibility date. For the spousal guaranteed lifetime withdrawal benefit rider, that amount may be then multiplied a predetermined spousal factor, e.g. 90%. The withdrawal percentage may be electronically calculated based on stored data, predetermined variables and the following formula: (age based percentage)+(cumulative deferral percentage)+(first year deferral percentage). The age based percentage can be predetermined, e.g. 4% for ages 60-64, 4.5% for ages 65-69 and 5% for ages 70 and over. The cumulative deferral percentage begins at zero and may increase by some set percentage, e.g. 0.10%, for each complete calendar year that a purchaser does not take a withdrawal. The first year deferral percentage can be predetermined based on the contract date, e.g. 0.075% for contact dates between January 1 and March 31, 0.05% for contract dates between April 1 and June 30, and so on.

In one preferred and non-limiting embodiment of the present invention, if a purchaser selects and purchases a rider to provide guaranteed lifetime payments, the issuing company (or system) may restrict the subaccounts investing in corresponding ETFs which the purchaser may invest in. This restriction may involve a limitation on the selections and viewable data transmitted to purchasers that have selected such a rider or guarantee. In one embodiment of the invention, the issuing company may transmit various models of asset allocation that a purchaser can select from. Possible types of allocation models may include blend, growth and value, each allocating different percentages of assets to different subaccounts investing in corresponding ETFs or other investment options.

In one preferred and non-limiting embodiment of the present invention, offers for static asset allocation models may be transmitted to purchasers in connection with the purchasers' variable annuities. Asset allocation is the process of investing in different asset classes, such as equity funds, fixed income funds, and alternative funds, depending on the purchaser's personal investment goals, tolerance for risk, and investment time horizon. By spreading their funds among a variety of asset classes, purchasers may be able to reduce the risk and volatility of investing. Educational information and materials, such as a risk tolerance questionnaire, may be electronically transmitted to purchasers to help them select an asset allocation model. Static asset allocation models will not change unless a purchaser transmits a request to the issuing company to do so. Further, purchasers choosing static asset allocation models may elect automatic rebalancing in which the issuing company will rebalance the purchaser's percentage allocations among the funds in the purchaser's existing model. Preferably, the system initiates the rebalancing functions automatically at specified time intervals, resulting in the generation of requests to purchase or sell units of subaccounts investing in corresponding ETFs.

In one preferred and non-limiting embodiment of the present invention, the issuing company (or system) may offer a Systematic Transfer Option (STO) that provides a fixed interest rate on each premium allocated to the STO. The STOs can be made available for any period of time and can require a minimum premium based on the selected period of time. Further, the STOs can be limited to new premiums only, so that purchasers cannot transfer funds from a subaccount into the STO. The issuing company may offer purchasers a Systematic Transfer Program which electronically transfers assets out of the STO to one or more subaccounts on a monthly or quarterly basis. If a purchaser does not have enough in the STO to transfer to each specified subaccount, a final transfer can be made on a pro rata basis and that purchaser's enrollment in the Systematic Transfer Program will end. All interest accrued and any account value remaining in the STO at the end of the period during which transfers are scheduled to be made will be transferred at the end of that period on a pro rata basis to the subaccounts a purchaser chose for the Systematic Transfer Program. The issuing company may restrict what funds may be transferred into the STO. Again, all of these communications may be provided on or facilitated by the presently-invented system.

In one preferred and non-limiting embodiment of the present invention, the issuing company (or system) may provide a customized asset rebalancing program. This program allows purchasers to maintain a diversified investment mix that is appropriate for that purchaser's goals and risk tolerance. Since different subaccounts may experience different gains and losses at different times, a purchaser's asset allocation may shift from that purchaser's preferred mix. An asset rebalancing program periodically resets a purchaser's investments to that purchaser's original allocations. This program ensures that a purchaser's asset allocation stays in line with that purchaser's investment strategy. Purchasers can transmit a request to the issuing company to rebalance monthly, quarterly, semi-annually, annually, or at any other interval allowed by the issuing company. Preferably, the system initiates the rebalancing functions automatically at the specified time intervals, resulting in the generation of requests to purchase or sell units of ETFs.

In one preferred and non-limiting embodiment of the present invention, the issuing company (or system) may provide a required minimum distribution program that allows purchasers to pre-authorize withdrawals from their IRAs after they attain seventy and one-half years of age, or any other specified age. The Internal Revenue Code requires owners to take minimum distributions on or before April 1^{st} of the calendar year following the calendar year in which the annuitant turns seventy and one-half years of age. These withdrawals are subject to ordinary income tax and can be made monthly, quarterly, semi-annually, annually or at any other specified time interval. Withdrawals under such a program may take the form of electronic funds transfers initiated by the system or other forms of payment including direct deposit.

In one preferred and non-limiting embodiment of the present invention, purchasers may be able to move money tax-free from one IRA to their account or from other qualified plans by means of a direct rollover or a transfer. The purchasers may rollover, directly or indirectly, any eligible rollover distribution. An eligible rollover distribution is defined generally as any distribution of all or part of the balance from a qualified plan, except purchasers cannot rollover specified taxable distributions from another plan, e.g. any distribution that is part of a series of substantially equal payments made over their life expectancy, any distribution made for a specified period of 10 years or more, and so on. These transactions can be initiated on or facilitated by the system.

The issuing company (or system) may deduct a charge based on a percentage of the account value which may be deducted from each of the subaccounts. This deduction may be initiated automatically by the system. This separate account charge may encompass the issuing company's separate account charges, which may include administrative expenses and a charge for assuming the mortality risk and expense risk. The issuing company may also choose to implement a withdrawal charge associated the withdrawal of any premiums. The amount of the withdrawal charge can be calculated based on a percentage of each premium and can vary depending on the number of years that have passed since each premium was paid. The withdrawal charge may be reduced or eliminated for an individual or a group of individuals if the issuing company anticipates expense savings. The system may be configured to electronically notify purchasers of any charges that may be deducted from their assets.

In one preferred and non-limiting embodiment of the present invention, the variable annuity contract may be purchased by applying to an authorized sales representative who then electronically transmits the completed application to the issuing company for approval. Sales representatives may include licensed insurance agents and registered representatives of broker-dealers or financial institutions that have entered into distribution agreements with the issuing company. A principal underwriter may also be appointed by the issuing company to underwrite the variable annuity contracts.

To reduce the risk of a price differential to an acceptable level, the issuing company can enter into an agreement wherein the company pays a fee to a third-party company or broker for the privilege of being able to purchase or sell ETF shares underlying variable annuity owners' unit transactions at the closing price of each ETF on the ETFs' primary exchanges. This privilege can be in the form of a commitment to the issuing company to trade ETF shares at the closing price of each primary exchange associated with each ETF. This commitment can include a guarantee or guarantees made to the issuing company.

To further reduce the risks associated with offering ETF investment options through a variable annuity, the basis risk may be hedged by investing in hedging options having an expected performance comparable to that of a chosen index-based ETF. By using index-based ETFs, issuing companies are able to better manage the market risk of its variable annuity contracts through improved hedging. Like ETFs, hedges are index-based and can include strategies such as purchasing short indexed futures positions or buying put options on a basket of equity indexes. Hedges can additionally include any derivative or derivative security, including but not limited to derivatives or derivative securities that will generate revenue to offset any losses from one or several ETFs.

Once a purchaser transmits a request to invest in a particular subaccount investing in a corresponding index-based ETF, the issuing company can hedge the risks involved with this investment by utilizing market data to determine how the index-based ETF is expected to perform. After data related to the expected performance of the ETF is generated, the system can then identify at least one index-based hedging option that, based on market data, is expected to perform similarly to the ETF. The issuing company may then initiate the purchase of the identified hedging options.

Using index-based hedging instruments to hedge the ETF indexes significantly reduces the likelihood of a mismatch between the hedge program and the performance of the ETFs. This ability to tightly hedge risks presents an advantage over other variable annuity products utilizing actively managed funds because actively managed funds inherently experience turnover of their underlying securities. While funds vary in the degree to which their underlying securities are turned over by the portfolio manager, the very nature of turnover necessarily affects the effectiveness of any attempted hedge. Ultimately, the effectiveness of an attempted hedge depends upon the mutual fund's correlation to the index used for hedging purposes. However, by definition, the performance of actively managed funds will vary from a perfect correlation to the index because those funds are attempting to beat, not merely match, the returns of the index.

Although index-based ETFs will not always be perfectly correlated to the index, their consistently high correlations permit a company issuing a variable annuity contract to manage risk to a much greater degree than competitors, providing a competitive advantage. This competitive advantage was recognized in a report issued by Moody's Investors Service stating that the invention would be easier to hedge because the ETF investment options are index-based, much like the hedges themselves. This reduces the likelihood of a mismatch between the hedge program and the performance of the ETFs, which causes hedging breakage.

In one non-limiting example of the present invention, illustrated in the table below, a variable annuity product includes a spousal guaranteed lifetime withdrawal benefit rider where withdrawals equal to the lifetime payment amount as well as nonguaranteed withdrawals have been taken and increases to the withdrawal percentage have been applied. The example also illustrates the termination of the rider if the account value is reduced to zero by a nonguaranteed withdrawal. In this example, amounts less than $1.00 are rounded and a number of non-limiting assumptions are made. The example assumes that the contract date is August 8, that the covered persons' ages as of the contract date are 60 years of age (owner) and 57 years of age (spouse), that the initial premium was $100,000, that no additional premiums were paid, that withdrawals equal to the lifetime payment amount were taken in calendar years 4-13, that a nonguaranteed withdrawal in calendar year 3 amounted to $10,000, that the full account value was withdrawn in calendar year 14, that no withdrawals were taken that would have resulted in withdrawal charges under the contract, that the required minimum distributions were not higher than the lifetime payment amount in any calendar year and that the rider remained in effect during the period covered in the example.

| Cal- | As of January 1 (A) | | | | | As of August 8 (B) | | As of October 8 (C) | | | |
|---|---|---|---|---|---|---|---|---|---|---|---|
| en- | Covered Persons' | | | | | Hypothetical | Benefit | Hypothetical | | Adjusted | Benefit Base |
| dar | Ages | | Withdrawal | Benefit | | Account | Base after | Account | Annual | Nonguaranteed | After |
| Year | Owner | Spouse | Percentage | Base | LPA | Value (D) | Step-Up | Value (D) | Withdrawal | Withdrawal | Withdrawal |
| 1 | | | | | | $100,000 | $100,000 | $99,625 | $0 | $0 | $100,000 |
| (E) | | | | | | (E) | (E) | | | | |
| 2 | 61 | 58 | N/A | $100,000 | N/A | $103,610 | $103,610 | $103,492 | $0 | $0 | $103,610 |
| | | | | | | | (F) | | | | |
| 3 | 62 | 59 | N/A | $103,610 | N/A | $106,597 | $106,597 | $107,299 | $10,000 | $10,000 | $96,597 |
| | | | | | | | | | (G) | (G) | (G) |
| 4 | 63 | 60 | 4.125% | $96,597 | $3,586 | $95,353 | $96,597 | $96,051 | $3,586 | $0 | $96,597 |
| | | | (H) | | (H) | | | | | | |
| 5 | 64 | 61 | 4.125% | $96,597 | $3,586 | $90,616 | $96,597 | $91,354 | $3,586 | $0 | $96,597 |
| 6 | 65 | 62 | 4.125% | $96,597 | $3,586 | $87,767 | $96,597 | $87,334 | $3,586 | $0 | $96,597 |
| 7 | 66 | 63 | 4.125% | $96,597 | $3,586 | $80,398 | $96,597 | $80,850 | $3,586 | $0 | $96,597 |
| 8 | 67 | 64 | 4.125% | $96,597 | $3,586 | $78,809 | $96,597 | $78,137 | $3,586 | $0 | $96,597 |
| 9 | 68 | 65 | 4.125% | $96,597 | $3,586 | $74,550 | $96,597 | $75,033 | $3,586 | $0 | $96,597 |
| 10 | 69 | 66 | 4.125% | $96,597 | $3,586 | $70,018 | $96,597 | $70,075 | $3,586 | $0 | $96,597 |
| 11 | 70 | 67 | 4.125% | $96,597 | $3,586 | $67,154 | $96,597 | $67,561 | $3,586 | $0 | $96,597 |
| 12 | 71 | 68 | 4.125% | $96,597 | $3,586 | $61,415 | $96,597 | $61,764 | $3,586 | $0 | $96,597 |
| 13 | 72 | 69 | 4.125% | $96,597 | $3,586 | $59,341 | $96,597 | $58,952 | $3,586 | $0 | $96,597 |
| 14 | 73 | 70 | 4.125% | $96,597 | $3,586 | $55,919 | $96,597 | $56,320 | $56,320 | N/A | $0 |
| | | | | | | | | | (I) | | |
| 15 | 74 | 71 | N/A | $0 | $0 | $0 | $0 | $0 | $0 | $0 | $0 |

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A computer-implemented method for providing and managing variable annuity funds, comprising:
a. receiving, on a server computer, a request to allocate an amount of annuity assets comprising tax-deferred or tax-advantaged assets into at least one subaccount corresponding to a specified exchange-traded fund;
b. allocating the amount of annuity assets into at least one subaccount; and
c. initiating the purchase of at least one share of an exchange-traded fund relating to at least a portion of at least one unit of the at least one subaccount.

2. The method of claim 1, wherein monetary distributions received from an exchange-traded fund are reinvested in at least one exchange-traded fund.

3. The method of claim 1, wherein the annuity assets comprise at least one of the following:
assets in at least one individual retirement account, payments from at least one individual retirement account, assets in at least one 401(k) account, assets in at least one 403(b) account, assets in at least one 457 account, assets in at least one individual retirement account formed under the Employee Retirement Income Security Act, assets from at least one retirement account annuity contract, consolidated tax-deferred or tax-advantaged assets, or any combination thereof.

4. The method of claim 1, further comprising:
a. receiving a guarantee from a contract owner to pay an annual payment fee; and
b. issuing a guarantee to pay the contract owner for the life of the annuitant in exchange for said annual payment fee.

5. The method of claim 1, further comprising:
a. determining expected performance data of the at least one exchange-traded fund;
b. identifying at least one index-based investment option having expected performance data substantially similar to said expected performance data of the at least one exchange-traded fund; and
c. initiating the purchase of said at least one index-based investment option.

6. The method of claim 5, wherein the at least one index-based investment option is at least one of the following: short indexed futures positions, put options on a basket of equity indexes, stock index futures, derivatives, derivative securities, or any combination thereof.

7. The method of claim 1, further comprising:
a. receiving a request to withdraw an amount of assets from a subaccount; and
b. initiating the sale of at least one share of the exchange-traded fund relating to at least a portion of at least one unit of the subaccount, wherein the at least one share of the exchange-traded fund relates to the amount of assets.

8. The method of claim 1, wherein annuity funds are allocated to a plurality of subaccounts, the method further comprising:
a. determining a purchaser's original asset allocation to each of the plurality of subaccounts; and
b. reallocating a purchaser's current assets in the plurality of subaccounts among the plurality of subaccounts, so that the current assets allocated among the plurality of subaccounts are allocated substantially proportional to the purchaser's original asset allocation to each of the plurality of subaccounts.

9. The method of claim 1, further comprising:
a. transmitting data configured to generate a display showing at least one of the following: account value, subaccount value, subaccount allocation, account history, or any combination thereof.

10. The method of claim 1, further comprising:
a. providing a graphical user interface designed to facilitate the allocation of assets to at least one subaccount.

11. The method of claim 1, further comprising:
a. determining a fee for at least one broker-dealer;
b. receiving a commitment from at least one broker-dealer to trade exchange-traded fund shares at the closing price of each primary exchange associated with each exchange-traded fund.

12. A computer program product comprising a computer usable medium having control logic stored therein for causing a computer to manage variable annuity funds, the control logic comprising:
a. first computer readable program code means for causing the computer to receive a request to allocate an amount of annuity assets comprising tax-deferred or tax-advantaged assets into at least one subaccount corresponding to a specified exchange-traded fund;
b. second computer readable program code means for causing the computer to allocate the amount of annuity assets into at least one subaccount; and
c. third computer readable program code means for causing the computer to initiate the purchase of at least one share of an exchange-traded fund relating to at least a portion of at least one unit of the at least one subaccount.

13. The computer program product of claim 12, further comprising:
a. fourth computer readable program code means for causing the computer to determine expected performance data of the at least one exchange-traded fund;
b. fifth computer readable program code means for causing the computer to identify at least one index-based investment option having an expected performance substantially similar to said expected performance of the at least one exchange-traded fund; and
c. sixth computer readable program code means for causing the computer to initiate the purchase of said at least one index-based investment option.

14. The computer program product of claim 12, further comprising:
a. fourth computer readable program code means for causing the computer to receive a request to withdraw an amount of assets from a subaccount; and
b. fifth computer readable program code means for causing the computer to initiate the sale of at least one share of the exchange-traded fund relating to at least a portion of at least one unit of the subaccount, wherein the at least one share of the exchange-traded fund relates to the amount of assets.

15. A variable annuity fund creation and management system, comprising:
a. at least one computer having a computer readable medium with program instructions stored thereon, which, when executed by a processor of the computer, cause the processor to:
i. receive a request to allocate an amount of annuity assets comprising tax-deferred or tax-advantaged assets into at least one subaccount corresponding to a specified exchange-traded fund;
ii. allocate the amount of annuity assets into the at least one subaccount; and
iii. initiate the purchase of at least one share of an exchange-traded fund relating to at least a portion of at least one unit of the at least one subaccount.

16. The system of claim 15, further comprising program instructions which, when executed by a processor of the computer, cause the processor to:
a. determine expected performance data of the at least one exchange-traded fund;
b. identify at least one index-based investment option having an expected performance substantially similar to said expected performance of the at least one exchange-traded fund; and
c. initiating the purchase of said at least one index-based investment option.

17. The system of claim 15, wherein the annuity assets are comprised of at least one of the following: assets in at least one individual retirement account, payments from at least one individual retirement account, assets in at least one 401(k) account, assets in at least one 403(b) account, assets in at least one 457 account, assets in at least one retirement account formed under the Employee Retirement Income Security Act, assets from at least one individual retirement account annuity contract, consolidated tax-deferred or tax-advantaged assets, or any combination thereof.

18. A computer-implemented method for reducing risk in a variable annuity product, comprising:
a. receiving, on a server computer, a request to invest assets in an index-based exchange-traded fund;
b. determining expected performance data of said index-based exchange-traded fund;
c. identifying at least one index-based investment option having an expected performance substantially similar to said expected performance of said index-based exchange-traded fund; and
d. communicating the identified at least one index-based investment option.

19. The method of claim 18, wherein the assets are comprised of at least one of the following: assets in at least one individual retirement account, payments from at least one individual retirement account, assets in at least one 401(k) account, assets in at least one 403(b) account, assets in at least one 457 account, assets in at least one retirement account formed under the Employee Retirement Income Security Act, assets from at least one individual retirement account annuity contract, consolidated tax-deferred or tax-advantaged assets, or any combination thereof.

20. The method of claim 18, further comprising:
a. receiving a guarantee from a contract owner to pay an annual payment fee; and
b. issuing a guarantee to pay the contract owner for the life of the annuitant in exchange for said annual payment fee.

21. The method of claim 18, further comprising:
a. transmitting data configured to generate a display showing at least one of the following: account value, subaccount value, subaccount allocation, account history, or any combination thereof.

22. The method of claim 18, further comprising:
a. providing a graphical user interface designed to allow users to allocate assets among subaccounts.

23. A computer program product comprising a computer usable medium having control logic stored therein for causing a computer to reduce risk in a variable annuity product, the control logic comprising:
a. first computer readable program code means for causing the computer to receive a request to invest assets in an index-based exchange-traded fund;
b. second computer readable program code means for causing the computer to determine expected performance data of said index-based exchange-traded fund;
c. third computer readable program code means for causing the computer to identify at least one index-based investment option having expected performance data substantially similar to said expected performance data of said index-based exchange-traded fund; and
d. fourth computer readable program code means for causing the computer to communicate the identified at least one index-based investment option.

24. A variable annuity fund risk-reduction system, comprising:
a. at least one computer having a computer readable medium with program instructions stored thereon, which, when executed by a processor of the computer, cause the processor to:
i. receive a request to invest assets in an index-based exchange-traded fund;
ii. determine expected performance data of said index-based exchange-traded fund;
iii. identify at least one index-based investment option having expected performance data substantially similar to said expected performance data of said index-based exchange-traded fund; and
iv. communicate the identified at least one index-based investment option.
